(19) United States
(12) Patent Application Publication
(10) Pub. No.: US 2021/0333141 A1
(43) Pub. Date: Oct. 28, 2021

(54) METHOD FOR ARRANGING SENSORS AND SENSOR ARRANGEMENT STRUCTURE

(71) Applicant: SHENZHEN CHINA STAR OPTOELECTRONICS SEMICONDUCTOR DISPLAY TECHNOLOGY CO., LTD., Shenzhen (CN)

(72) Inventors: Jing ZHANG, Shenzhen (CN); Chenjie LI, Shenzhen (CN); Junjun WANG, Shenzhen (CN); Fei MA, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/617,506

(22) PCT Filed: Aug. 2, 2019
(86) PCT No.: PCT/CN2019/099034

§ 371 Date: Nov. 27, 2019

(30) Foreign Application Priority Data
May 28, 2019 (CN) 201910449320.8

(51) Int. Cl. G01F 25/00; G01L 25/00; B08B 13/00

(52) U.S. Cl. CPC G01F 25/0061; B08B 3/00; B08B 13/00; G01L 25/00

(57) ABSTRACT

A method for arranging sensors and a sensor arrangement structure, pair sensors by adding an additional sensor, and sets an operating mode between the sensors in an “OR” mode by a software. When one of the sensors become abnormal, an apparatus operates normally, which lowers a probability of crash of the apparatus, reduces loss of production capacity and raises production rate.

### FIELD OF INVENTION

The present invention relates to a field of display panel apparatus manufacture, especially to a method for arranging sensors and a sensor arrangement structure.

### BACKGROUND OF INVENTION

With the development of the times and the advancement of optoelectronic technology, people's demand for various electronic devices is increasing. Accordingly, people's requirements for display panels are getting higher and higher. The production of display panels includes many processes, of which wet cleaning apparatus production is a very important part.

In the wet cleaning apparatus production, contact sensors and liquid level sensors occasionally become abnormal. Although a probability of abnormality is very low, which only occupies about 0.1% of a total operation time, but however, the contact sensors and liquid level sensors, when becoming abnormal, cause abnormality of transport. At the meantime, the apparatus crashes and stop producing such that a yield thereof is drastically lowered, pressure of production increases, and production rate is influenced.

Therefore, it is necessary to set forth a solution for the issue of the prior art.

### SUMMARY OF INVENTION

### Technical Issue

An objective of the present invention is to provide a method for arranging sensors and a new sensor arrangement structure to solve the technical issue in the prior art.

### Technical Solution

To solve the above issue, a method for arranging sensors provided by the present invention comprises following steps:

disposing a pair of sensors, wherein the sensors are disposed oppositely; and

setting an operating mode between the sensors in an “OR” mode; and

operating an apparatus normally when at least one of the sensors operates normally.

In an embodiment, the step of setting the operating mode between the sensors in the “OR” mode is set by a software.

In an embodiment, the software also sets a prewarning mechanism.

In an embodiment, the prewarning mechanism is that: the software triggers prewarning when one of the sensors is abnormal.

In an embodiment, the apparatus stops operating when the pair of the sensors are abnormal.

To solve the above issue, a sensor arrangement structure provided by the present invention comprises a pair of sensors, the sensors are disposed oppositely; and an operating mode between the sensors is set in an “OR” mode; and an apparatus operates normally when at least one of the sensors operates normally.

In an embodiment, the operating mode between the sensors is set by a software.

In an embodiment, the software also sets a prewarning mechanism.

In an embodiment, the prewarning mechanism is that: the software triggers prewarning when one of the sensors is abnormal.

In an embodiment, the apparatus stops operating when the pair of the sensors are abnormal.

### Advantages

Compared to the prior art, a method for arranging sensors and a sensor arrangement structure of the present invention comprise pairing sensors by adding an additional sensor; setting an operating mode between the sensors as “OR” mode by a software, wherein an apparatus operates normally when one of the sensors is abnormal. The software sets a prewarning mechanism, prewarning is triggered when one of the pair of the sensors becomes abnormal such that the abnormal part can be replaced during maintenance or idle time, which lowers probability of the crashing apparatus, reduces loss of production capacity and raises production rate.

### DESCRIPTION OF DRAWINGS

FIG. 1 is a flowchart of a method for arranging sensors provided by an embodiment of the present invention;

FIG. 2 is a schematic view of a structure of a contact sensor of an embodiment of the present invention;

FIG. 3 is a schematic view of a structure of a liquid level sensor of an embodiment of the present invention; and

FIG. 4 is a schematic view of a sensor arrangement structure of an embodiment of the present invention.

### DETAILED DESCRIPTION OF PREFERRED EMBODIMENTS

Explanation of the following embodiments refer to the accompanying drawings for illustrating the specific embodiments of the present invention.

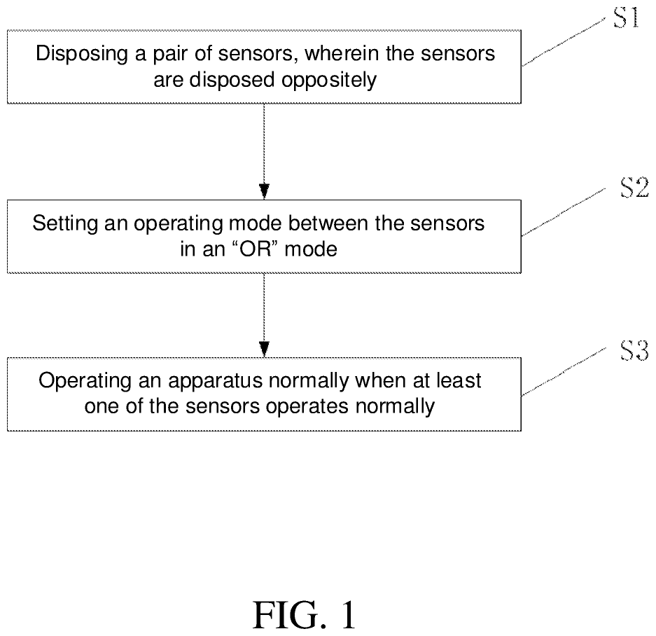

The present invention provides a method for arranging sensors, as shown in FIG. 1. FIG. 1 is a flowchart of a method for arranging sensors provided by an embodiment of the present invention. The method comprises steps as follows:

step S1, disposing a pair of sensors, wherein the sensors are disposed oppositely;

step S2, setting an operating mode between the sensors in an “OR” mode;

step S3, operating an apparatus normally when at least one of the sensors operates normally.

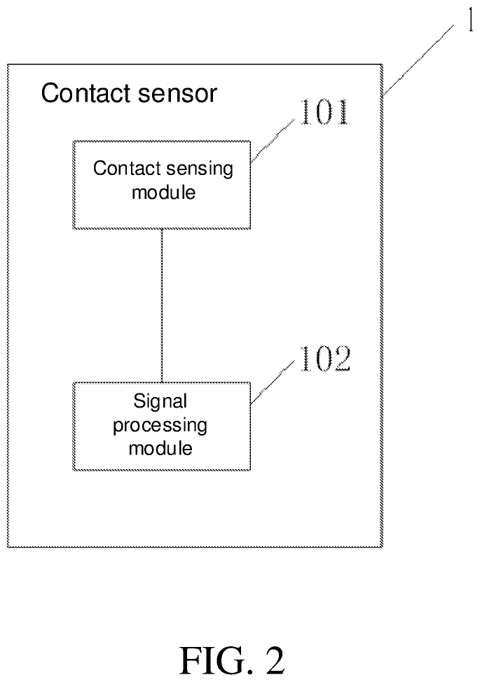

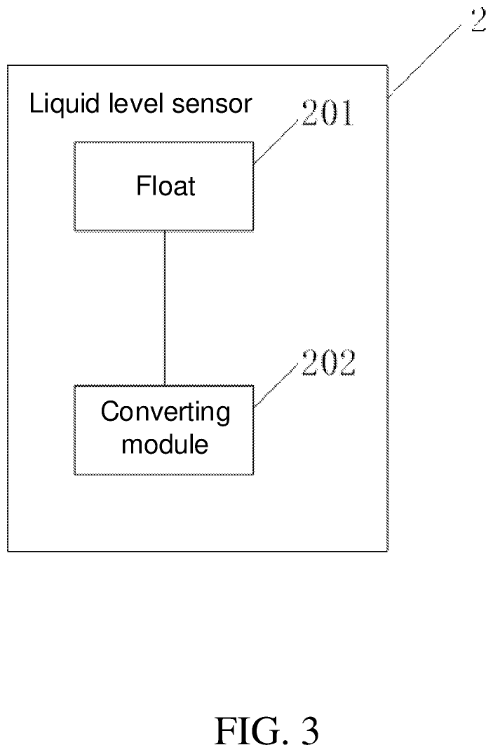

With reference to FIGS. 2 and 3. FIG. 2 is a schematic view of a structure of a contact sensor of an embodiment of the present invention, and FIG. 3 is a schematic view of a structure of a liquid level sensor of an embodiment of the present invention. During the production of a wet cleaning apparatus, many sensors are used. In the current environment, a single sensor is presented. However, in real production, the single sensor such as a contact sensor and a liquid level sensor occasionally become abnormal. For example, sensing signal is abnormal or a hardware is jammed. Although a probability of abnormality is very low, which only occupies about 0.1% of a total operation time, but however, the contact sensor 1 and liquid level sensor 2, when becoming abnormal, cause abnormality of transport. At the meantime, the apparatus crashes and stop producing such that a yield thereof is drastically lowered, pressure of production increases, and production rate is influenced.

In the present embodiment, the step S1 is specifically that: in the present embodiment, disposing a pair of sensors. In other words, on the basis of an original sensor, an additional sensor is added to pair the sensors. The pair of the sensors is optionally disposed oppositely, disposed in parallel, or disposed vertically depending on actual conditions.

In the present embodiment, the step S2 is specifically that: an operating mode is set for the pair of the sensors disposed in a position, and a way for setting the operating mode is optionally chosen according to actual conditions. Preferably, in the present embodiment, the operating mode of the sensors is set in an “OR” mode by a software. Simultaneously, to detect abnormal conditions of the sensors in time, in the present embodiment, software also sets a prewarning mode.

In the present embodiment, the step S3 is specifically that: when the operating mode has set the completed sensors to operate, if an abnormal condition happens, for example a sensing signal is abnormal or a hardware is jammed, because the operating mode between the sensors is set in the “OR” mode by the software, as long as one of the sensors operates normally, the apparatus will operate normally. In other words, when one of the contact sensors 1 is abnormal, the apparatus does not crash as before and can still operate normally, which enhances the production rate. At this time, the prewarning mechanism of the software is also triggered to warn a related staff member that the sensor become abnormal. The related staff member can replace the abnormal part during a stop period of the apparatus, for example, during maintenance or an idle period.

Furthermore, when both the pair of the sensors operate normally, the apparatus operates normally. When both the pair of the sensors are in an abnormal condition, for safety and insurance of the yield rate of the products and saving of producing material, the apparatus stops operating.

In the present embodiment, sensors are preferred to be contact sensors 1 or liquid level sensors 2. The method for arranging sensors of the present embodiment can be applied to a wet cleaning apparatus for display panel products.

With reference to FIG. 2, the contact sensor 1 in an embodiment of the present invention comprises: a contact sensing module 101 and a signal processing module 102.

The contact sensing module 101 is configured to sense objects, transmit a first signal or a second signal. In the present embodiment, the contact sensing module 101 is configured to sense a glass. When transported here, the glass presses against contact sensing module 101. At this time, the contact sensing module 101 transmits the first signal. In the present embodiment, the first signal is an “ON” signal, and is configured to indicate an existence of the glass. When the glass is transported away or is not transported here, the contact sensing module 101 transmits a second signal. In the present embodiment, the second signal is an “OFF” signal, and is configured to indicate absence of the glass. The function of transmitting the second signal can be optionally function not to transmit a signal. When the signal processing module 102 detects no first signal from the contact sensing module 101, the signal processing module 102 determines that no glass exists.

The signal processing module 102 is configured to process the first signal or the second signal from the contact sensing module 101. In the present embodiment, the signal processing module 102 processes the “ON” signal or “OFF” signal from the contact sensing module 101. The signal processing module 102 processes “ON” signal or “OFF” signal, and converts the signal into a signal identified by a related apparatus, for example, an electrical signal. If the function of transmitting a second signal is chosen to be transmit no signal, when the signal processing module 102 detects no first signal from the contact sensing module 101, the signal processing module 102 determines no existence of the glass.

With reference to FIG. 3, is a schematic view of a structure of a liquid level sensor 2 of an embodiment of the present invention. The liquid level sensor 2 comprises: a float 201 and a converting module 202.

In the present embodiment, the float 201, according a principle of the volume of the liquid being the volume of the object, floats on a liquid level of the container. When the liquid level of the container changes, the float 201 move up and down accordingly. Because magnetic effect, variation of a position of the float 201 causes variation of a value of a resistance of the liquid level sensors 2. The converting module 202 converts the variation of the resistance into a signal that can be identified by a related apparatus such as an electrical signal. Finally a function of reflecting a current liquid level of the container.

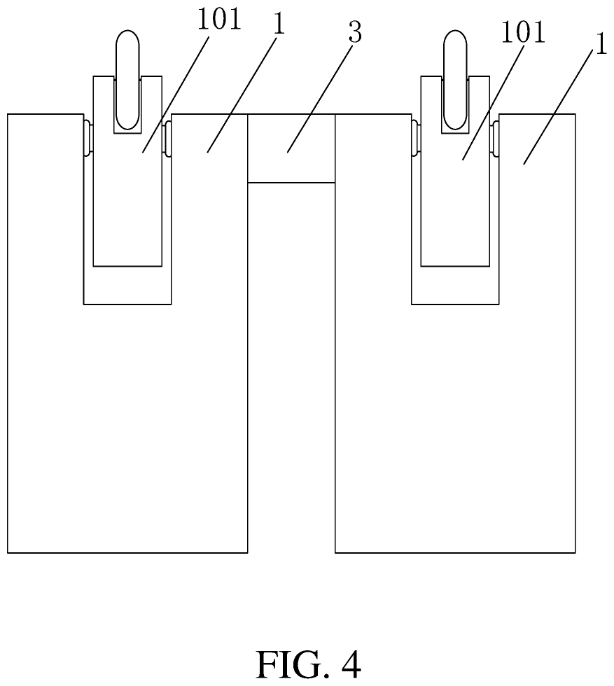

The present invention embodiment also provides a sensor arrangement structure, as shown in FIG. 4. FIG. 4 is a schematic view of a sensor arrangement structure of an embodiment of the present invention. The sensor arrangement structure comprises two sensors, and the sensors are disposed oppositely. In the present embodiment, preferably, the sensors are contact sensors 1.

Each of the contact sensors 1 comprises a contact sensing module 101. In the present embodiment, the contact sensing module 101 is disposed on an upper portion of the contact sensors 1. When transported here, a product on the apparatus presses against the contact sensing module 101, the contact sensing module 101 transmits a signal to indicate coming of the product. The contact sensors 1 are disposed oppositely. In the present embodiment, one of the contact sensors 1 is connected to the other contact sensors 1 by a connecting device 3, and the two are in a straight line. In the present embodiment, the contact sensors 1 can be connected to the signal processing module, and the signal processing module determines whether the product is detected by the contact sensors 1 according to the signals transmitted from the contact sensing module 101.

In the present embodiment, the operating mode between the contact sensors 1 is set in an “OR” mode, and a way of setting the operating mode depends on actual conditions. Preferably, in the present embodiment, the operating mode of the contact sensors 1 is set in the “OR” mode by a software. The “OR” mode is specifically that:

When a pair of contact sensors 1 operate, if an abnormal condition happens, for example a sensing signal is abnormal or a hardware is jammed, as long as one of the contact sensors 1 operates normally, the apparatus will operate normally. In other words, when one of the sensors is abnormal, the apparatus does not crash as before and can still operate normally, which enhances the production rate.

When both a pair of contact sensors 1 operate normally, the apparatus operates normally.

When both the pair of the contact sensors 1 are in an abnormal condition, for safety and insurance of the yield rate of the products and saving of producing material, the apparatus stops operating.

Furthermore, the software also sets a prewarning mechanism, the prewarning mechanism is that: when one of a pair of contact sensors 1 is abnormal, the software triggers prewarning to warn a related staff member of the abnormal contact sensors 1. The related staff member can replace the abnormal part during a stop period of the apparatus, for example, during maintenance or an idle period. The sensor arrangement structure of the present invention embodiment can be applied to a wet cleaning apparatus of the display panel.

Compared to the prior art, a method for arranging sensors and a sensor arrangement structure of the present invention comprise pairing sensors by adding an additional sensor; setting an operating mode between the sensors as “OR” mode by a software, wherein an apparatus operates normally when one of the sensors is abnormal. The software sets a prewarning mechanism, prewarning is triggered when one of the pair of the sensors becomes abnormal such that the abnormal part can be replaced during maintenance or idle time, which lowers probability of the crashing apparatus, reduces loss of production capacity and raises production rate.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

### INDUSTRIAL APPLICABILITY

The subject matter of the present invention can be manufactured and applied in industries and therefore has industrial applicability.

What is claimed is:

1. A method for arranging sensors, comprising following steps:
disposing a pair of sensors, wherein the sensors are disposed oppositely; and
setting an operating mode between the sensors in an “OR” mode; and
operating an apparatus normally when at least one of the sensors operates normally.

2. The method for arranging sensors as claimed in claim 1, wherein the step of setting the operating mode between the sensors in the “OR” mode is set by a software.

3. The method for arranging sensors as claimed in claim 2, wherein the software also sets a prewarning mechanism.

4. The method for arranging sensors as claimed in claim 3, wherein the prewarning mechanism is that:
the software triggers prewarning when one of the sensors is abnormal.

5. The method for arranging sensors as claimed in claim 1, wherein the apparatus stops operating when the pair of the sensors are abnormal.

6. A sensor arrangement structure, comprising a pair of sensors, wherein
the sensors are disposed oppositely; and
an operating mode between the sensors is set in an “OR” mode; and
an apparatus operates normally when at least one of the sensors operates normally.

7. The sensor arrangement structure as claimed in claim 6, wherein the operating mode between the sensors is set by a software.

8. The sensor arrangement structure as claimed in claim 7, wherein the software also sets a prewarning mechanism.

9. The sensor arrangement structure as claimed in claim 8, wherein the prewarning mechanism is that:
the software triggers prewarning when one of the sensors is abnormal.

10. The sensor arrangement structure as claimed in claim 6, wherein the apparatus stops operating when the pair of the sensors are abnormal.
